(19) United States
(12) Patent Application Publication
(10) Pub. No.: US 2014/0118967 A1
(43) Pub. Date: May 1, 2014

(54) SENSOR PACKAGE FOR TOUCH PANEL AND METHOD OF MANUFACTURING THE SAME

(71) Applicant: SAMSUNG ELECTRO-MECHANICS CO., LTD., Suwon (KR)

(72) Inventors: Seung Min Lee, Suwon (KR); Youn Soo Kim, Suwon (KR); Ha Yoon Song, Suwon (KR); Ho Joon Park, Suwon (KR)

(73) Assignee: SAMSUNG ELECTRO-MECHANICS CO., LTD., Suwon (KR)

(21) Appl. No.: 13/831,583

(22) Filed: Mar. 15, 2013

(30) Foreign Application Priority Data
Oct. 30, 2012 (KR) 10-2012-0121187

(51) Int. Cl. G06F 1/16

(52) U.S. Cl. CPC G06F 1/169
USPC 361/749; 361/767; 29/831

(57) ABSTRACT

Disclosed herein a sensor package for a touch panel and a method of manufacturing the same, the sensor package for the touch panel including: a printed circuit board; a sensor formed over the printed circuit board so as to be spaced apart from the printed circuit board; printed circuit board side connecting pads formed on one surface of the printed circuit board; sensor side connecting pads formed on one surface of the sensor and formed to face the printed circuit board side connecting pads; a first insulating layer formed between the printed circuit board side connecting pads on one surface of the printed circuit board; and a second insulating layer formed between the printed circuit board side connecting pad and the sensor side connecting pad and including conductive balls.

### CROSS REFERENCE TO RELATED APPLICATION

This application claims the benefit of Korean Patent Application No. 10-2012-0121187, filed on Oct. 30, 2012, entitled “Sensor Package for touch Panel and Method of Manufacturing the Same”, which is hereby incorporated by reference in its entirety into this application.

### BACKGROUND OF THE INVENTION

1. Technical Field

The present invention relates to a sensor package for a touch panel and a method of manufacturing the same.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has been widening the use of computers more and more, it is difficult to efficiently operate products using only a keyboard and mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, various kinds of touch panel including a prior art document 1 has been developed as an input device capable of inputting information such as text, graphics, or the like.

The touch panel is mounted on a display surface of an image display device such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the image display device.

The touch panel may be classified into a resistive type touch panel, a capacitive type touch panel, an electromagnetic type touch panel, a surface acoustic wave (SAW) type touch panel, and an infrared type touch panel.

A sensor for sensing a variety of signals among the configurations which are applied to the touch panel as described above is mounted on a flexible printed circuit board, wherein there is required a technology capable of easily connecting between the sensor and the flexible printed circuit board and preventing a short phenomenon while being operated.

### PRIOR ART DOCUMENT

### Patent Document

(Patent Document 1) US 2011-0304578 A

### SUMMARY OF THE INVENTION

The present invention has been made in an effort to provide a sensor package for a touch panel capable of easily connecting between a sensor and a printed circuit board and preventing a short phenomenon or the like between configurations upon operating a product in advance to thereby have improved reliability and a method of manufacturing the same.

According to a preferred embodiment of the present invention, there is provided a sensor package for a touch panel, including: a printed circuit board having one surface and the other surface; a sensor having one surface and the other surface and formed over the printed circuit board so as to be spaced apart from the printed circuit board; printed circuit board side connecting pads formed on one surface of the printed circuit board; sensor side connecting pads formed on one surface of the sensor and formed to face the printed circuit board side connecting pads; a first insulating layer formed between the printed circuit board side connecting pads on one surface of the printed circuit board; and a second insulating layer formed between the printed circuit board side connecting pad and the sensor side connecting pad and including conductive balls.

The printed circuit board may be a flexible printed circuit board (FPCB).

The second insulating layer may be made of an anisotropic conductive adhesive (ACA) or an anisotropic conductive film (ACF).

The first insulating layer may have a size larger than that of the printed circuit board side connecting pad based on a thickness direction of the printed circuit board.

The first insulating layer may have the same size as the sum of a size of the printed circuit board side connecting pad, a size of the second insulating layer, and a size of the sensor side connecting pad based on a thickness direction of the printed circuit board.

According to another preferred embodiment of the present invention, there is provided a method of manufacturing a sensor package for a touch panel, the method including: preparing a printed circuit board having one surface and the other surface and including printed circuit board side connecting pads on one surface thereof; preparing a sensor having one surface and the other surface and including sensor side connecting pads on one surface thereof; forming a first insulating layer between the printed circuit board side connecting pads on one surface of the printed circuit board; forming a second insulating layer including conductive balls on the sensor side connecting pad; and coupling the printed circuit board side connecting pad, the first insulating layer and the second insulating layer by disposing the printed circuit board and the sensor to face each other.

In the preparing of the printed circuit board, the printed circuit board may be a flexible printed circuit board (FPCB).

In the forming of the first insulating layer, the first insulating layer may be in a semi-hardened state.

In the forming of the first insulating layer, the first insulating layer may have a size larger than that of the printed circuit board side connecting pad based on a thickness direction of the printed circuit board.

In the forming of the first insulating layer, the first insulating layer may have the same size as the sum of a size of the printed circuit board side connecting pad, a size of the second insulating layer, and a size of the sensor side connecting pad based on a thickness direction of the printed circuit board.

In the forming of the second insulating layer, the second insulating layer may be to made of an anisotropic conductive adhesive (ACA) or an anisotropic conductive film (ACF).

In the forming of the second insulating layer, the second insulating layer may be in a semi-hardened state.

In the forming of the second insulating layer, the second insulating layer may be formed on the sensor side connecting pad through a screen print process.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a configuration of a sensor package for a touch panel according to a preferred embodiment of the present invention; and

FIGS. 2 to 7 are cross-sectional views sequentially describing a method of manufacturing the sensor package for the touch panel shown in FIG. 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first”, “second”, and so on are used to distinguish one element from another element, and the elements are not defined by the above terms.

Hereinafter, preferred embodiments of the present invention will be described in detail with reference to the accompanying drawings.

A sensor disclosed in a detailed description for embodying the present invention may include all of various kinds of optical sensors, magnetic sensors, screen touch sensors, and the like, which are applied to a touch panel capable of sensing a motion, reacting according to a sound, inputting an indication displayed on a screen when being pushed by a fingertip, but is not limited thereto.

### Sensor Package for Touch Panel

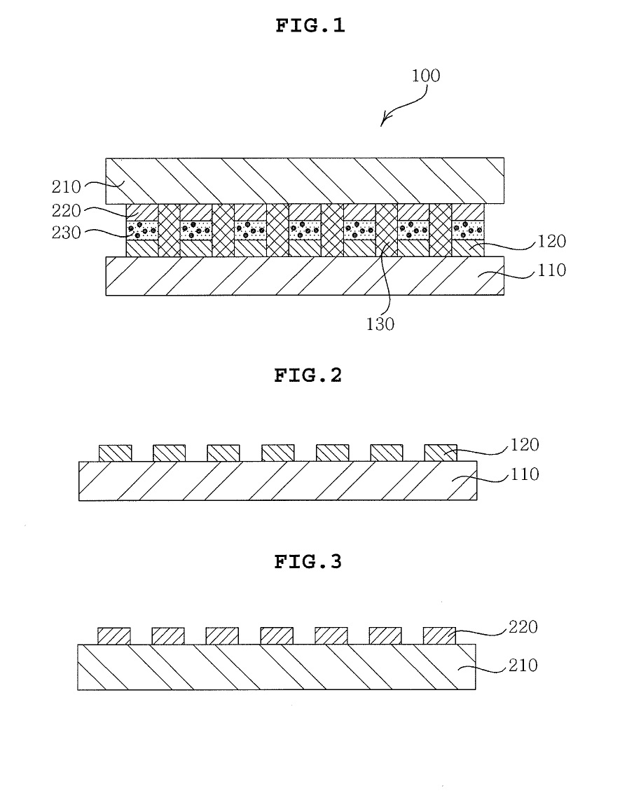

FIG. 1 is a view showing a configuration of a sensor package for a touch panel according to a preferred embodiment of the present invention.

As shown in FIG. 1, a sensor package 100 for a touch panel may include a printed circuit board 110 having one surface and the other surface, a sensor 210 having one surface and the other surface and formed over the printed circuit board 110 so as to be spaced apart from the printed circuit board, printed circuit board side connecting pads 120 formed on one surface of the printed circuit board 110, sensor side connecting pads 220 formed on one surface of the sensor 210 and formed to face the printed circuit board side connecting pads 120, first insulating layers 130 formed between the printed circuit board side connecting pads 120 of one surface of the printed circuit board 110, and second insulating layers 230 formed between the printed circuit board side connecting pad 120 and the sensor side connecting pad 220 and including conductive balls (233 in FIG. 5).

In this configuration, while the conductive balls (233 in FIG. 5) in the second insulating layer 230 are illustrated in the state in which they are spaced apart from each other at a predetermined interval in FIG. 1, it will be apparent that since an application of the electric current is performed by the conductive balls, the conductive balls are formed so as to be closely adhered to each other or formed in the state in which they are spaced apart from each other within a range capable of applying electric current.

The printed circuit board 110 may be a flexible printed board (FPCB).

In addition, the second insulating layer 230 may be made of an anisotropic conductive adhesive (ACA) or an anisotropic conductive film (ACF). However, the second insulating layer 230 is not limited to being made of the above-mentioned material, but may be made of any insulating material including a conductive ball made of a conductive material.

In addition, the first insulating layer 130 may have a size larger than that of the printed circuit board side connecting pad 120 based on a thickness direction of the printed circuit board.

In this case, the first insulating layer 130 may be formed of any insulating materials which do not include the conductive ball, including a resin.

In addition, the first insulating layer 130 may have the same size as the sum of a size of the printed circuit board side connecting pad 120, a size of the second insulating layer 230, and a size of the sensor side connecting pad 220 based on the thickness direction of the printed circuit board.

Here, the term same does not mean a thickness of accurately the same dimension in a mathematical meaning, but means substantially the same in consideration of a design error, a manufacturing error, a measuring error, or the like.

Since the structure in which the first insulating layer 130 has a size larger than that of the printed circuit board side connecting pad 120 based on a thickness direction of the printed circuit board or has the same size as the sum of the size of the printed circuit board side connecting pad 120, the size of the second insulating layer 230, and the size of the sensor side connecting pad 220 may have a form in which the insulating material not including the conductive ball is filled between the printed circuit board side connecting pads 120 and between the sensor side connecting pads, then a short phenomenon which may occur at the sensor side connecting pad or the printed circuit board side connecting pad upon operating a product may be prevented in advance.

### Method of Manufacturing Sensor Package for Touch Panel

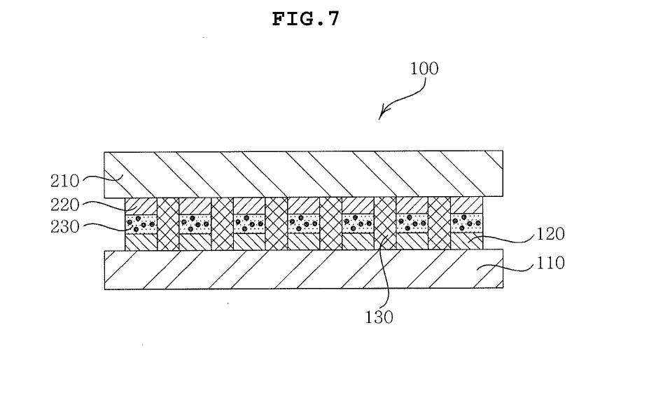

FIGS. 2 to 7 are cross-sectional views sequentially describing a method of manufacturing the sensor package for the touch panel shown in FIG. 1.

First, as shown in FIG. 2, a printed circuit board 110 having one surface and the other surface and including printed circuit board side connecting pads 120 on one surface thereof may be prepared.

In this case, the printed circuit board 110 may be a flexible printed board (FPCB).

Next, as shown in FIG. 3, a sensor 210 having one surface and the other surface and including sensor side connecting pads 220 on one surface thereof may be prepared.

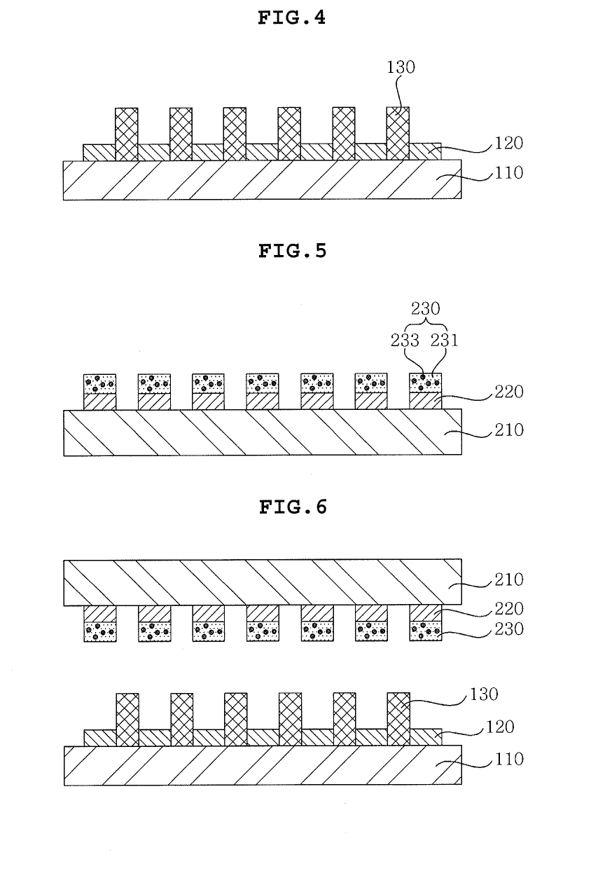

Next, as shown in FIG. 4, a first insulating layer 130 may be formed between the printed circuit board side connecting pads 120 of one surface of the printed circuit board 110.

Here, the first insulating layer 130 may be in a semi-hardened state.

In addition, the first insulating layer 130 may have a size larger than that of the printed circuit board side connecting pad 120 based on a thickness direction of the printed circuit board.

In this case, the first insulating layer 130 may be formed of any insulating materials which do not include the conductive ball, including a resin.

In addition, the first insulating layer 130 may have the same size as the sum of a size of the printed circuit board side connecting pad 120, a size of the second insulating layer 230, and a size of the sensor side connecting pad 220 based on the thickness direction of the printed circuit board.

Here, the term ‘same’ does not mean a thickness of accurately the same dimension in a mathematical meaning, but means substantially the same in consideration of a design error, a manufacturing error, a measuring error, or the like.

Since the structure in which the first insulating layer 130 has a size larger than that of the printed circuit board side connecting pad 120 based on a thickness direction of the printed circuit board or has the same size as the sum of the size of the printed circuit board side connecting pad 120, the size of the second insulating layer 230, and the size of the sensor side connecting pad 220 may have a form in which the insulating material not including the conductive ball is filled between the printed circuit board side connecting pads 120 and between the sensor side connecting pads, then short phenomenon which may occur at the sensor side connecting pad or the printed circuit board side connecting pad upon operating a product may be prevented in advance.

Next, as shown in FIG. 5, the second insulating layer 230 including the conductive balls 233 may be formed on the sensor side connecting pad 220.

Here, the second insulating layer 230 may have form in which the conductive ball 233 is included in the insulating material 231 such as the resin and the insulating material of reference numeral 231 may be the same or similar resin as that of the first insulating layer 130.

In addition, the second insulating layer 230 may be made of an anisotropic conductive adhesive (ACA) or an anisotropic conductive film (ACF).

In addition, the second insulating layer 230 may be in a semi-hardened state.

In addition, the second insulating layer 230 may be formed on the sensor side connecting pad 220 through a screen print process, but is not limited thereto.

Next, as shown in FIG. 6, the printed circuit board 110 and the sensor 210 are disposed to face each other, such that the printed circuit board side connecting pad 120, the first insulating layer 130, and the second insulating layer 230 may be coupled to each other.

For example, the printed circuit board side connecting pad 120 is coupled to contact the second insulating layer 230 and the first insulating layer 130 is coupled so as to be inserted between the sensor side connecting pads 220.

In this configuration, since the coupling is performed through a process in which the first insulating layer 130 is inserted between the sensor side connecting pads 220 in the state in which the first insulating layer 130 is formed in advance between the printed circuit board side connecting pads 120, a joint process may be easy.

In addition, the coupling process may be performed through a thermal-compression process, but is not limited thereto.

With the preferred embodiment of the present invention as described above, the insulating layer formed between a plurality of printed circuit board side connecting pads and the insulating layer formed between the printed circuit board side connecting pad and the sensor side connecting pad are formed of materials different from each other, thereby overcoming the defect phenomenon such as the short upon operating the product.

In addition, in accordance with the preferred embodiment, since the conductive balls capable of applying the electric current are only disposed between the sensor side connecting pad and the printed circuit board side connecting pad, the density of the conductive balls may be improved, thereby making it possible to clarify the connecting point to improve operational reliability of the product.

Here, according to the preferred embodiment of the present invention, since the conductive balls are only disposed between the sensor side connecting pad and the printed circuit board side connecting pad, the conductive balls which are relatively high cost are less used, as compared with the structure in which the conductive balls are formed on the entire surface between the printed circuit board and the sensor, thereby making it possible to reduce a product production cost.

With the sensor package for the touch panel and the method of manufacturing of the same according to the preferred embodiment of the present invention, the insulating layer formed between a plurality of printed circuit board side connecting pads and the insulating layer between the printed circuit board side connecting pad and the sensor side connecting pad are formed of materials different from each other, thereby making it possible to overcome the defect phenomenon such as the short upon operating the product.

In addition, in accordance with the preferred embodiment, since the conductive balls capable of applying the electric current are only disposed between the sensor side connecting pad and the printed circuit board side connecting pad, the density of the conductive balls may be improved, thereby making it possible to clarify the connecting point to improve operational reliability of the product.

In addition, in accordance with the preferred embodiment of the present invention, since the insulating layer having the size larger than that of the pads based on the thickness direction of the printed circuit board is formed in advance between the plurality of printed circuit board side connecting pads, the work related to the align upon coupling between the printed circuit board and the sensor becomes easy, thereby making it possible to increase assembly yield to improve productivity of the product.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A sensor package for a touch panel, comprising:
a printed circuit board having one surface and the other surface;
a sensor having one surface and the other surface and formed over the printed circuit board so as to be spaced apart from the printed circuit board;
printed circuit board side connecting pads formed on one surface of the printed circuit board;
sensor side connecting pads formed on one surface of the sensor and formed to face the printed circuit board side connecting pads;
a first insulating layer formed between the printed circuit board side connecting pads on one surface of the printed circuit board; and
a second insulating layer formed between the printed circuit board side connecting pad and the sensor side connecting pad and including conductive balls.

2. The sensor package for the touch panel as set forth in claim 1, wherein the printed circuit board is a flexible printed circuit board (FPCB).

3. The sensor package for the touch panel as set forth in claim 1, wherein the second insulating layer is made of an anisotropic conductive adhesive (ACA) or an anisotropic conductive film (ACF).

4. The sensor package for the touch panel as set forth in claim 1, wherein the first insulating layer has a size larger than that of the printed circuit board side connecting pad based on a thickness direction of the printed circuit board.

5. The sensor package for the touch panel as set forth in claim 1, wherein the first insulating layer has the same size as the sum of a size of the printed circuit board side connecting pad, a size of the second insulating layer, and a size of the sensor side connecting pad based on a thickness direction of the printed circuit board.

6. A method of manufacturing a sensor package for a touch panel, the method comprising:
preparing a printed circuit board having one surface and the other surface and including printed circuit board side connecting pads on one surface thereof;
preparing a sensor having one surface and the other surface and including sensor to side connecting pads on one surface thereof;
forming a first insulating layer between the printed circuit board side connecting pads on one surface of the printed circuit board;
forming a second insulating layer including conductive balls on the sensor side connecting pad; and
coupling the printed circuit board side connecting pad, the first insulating layer and the second insulating layer by disposing the printed circuit board and the sensor to face each other.

7. The method as set forth in claim 6, wherein in the preparing of the printed circuit board, the printed circuit board is a flexible printed circuit board (FPCB).

8. The method as set forth in claim 6, wherein in the forming of the first insulating layer, the first insulating layer is in a semi-hardened state.

9. The method as set forth in claim 6, wherein in the forming of the first insulating layer, the first insulating layer has a size larger than that of the printed circuit board side connecting pad based on a thickness direction of the printed circuit board.

10. The method as set forth in claim 6, wherein in the forming of the first insulating layer, the first insulating layer has the same size as the sum of a size of the printed circuit board side connecting pad, a size of the second insulating layer, and a size of the sensor side connecting pad based on a thickness direction of the printed circuit board.

11. The method as set forth in claim 6, wherein in the forming of the second insulating layer, the second insulating layer is made of an anisotropic conductive adhesive (ACA) or an anisotropic conductive film (ACF).

12. The method as set forth in claim 6, wherein in the forming of the second insulating layer, the second insulating layer is in a semi-hardened state.

13. The method as set forth in claim 6, wherein in the forming of the second insulating layer, the second insulating layer is formed on the sensor side connecting pad through a screen print process.
